(19) United States
(12) Patent Application Publication
(10) Pub. No.: US 2025/0368674 A1
(43) Pub. Date: Dec. 4, 2025

(54) POLYOLEFIN COMPOSITIONS FOR FILMS

(71) Applicant: Dow Global Technologies LLC, Midland, MI (US)

(72) Inventors: Rhett A. Baillie, Missouri City, TX (US); Rahul Sharma, Pearland, TX (US); Xiaosong Wu, Sugar Land, TX (US)

(21) Appl. No.: 18/875,790

(22) PCT Filed: Aug. 4, 2023
(86) PCT No.: PCT/US2023/029536

§ 371 Date: Dec. 17, 2024

Related U.S. Application Data
(60) Provisional application No. 63/395,376, filed on Aug. 5, 2022.
(60) Provisional application No. 63/395,369, filed on Aug. 5, 2022.

(51) Int. Cl. C07F 17/00; C08F 10/06

(52) U.S. Cl. CPC C07F 17/00; C08F 10/06

(57) ABSTRACT

Embodiments of the present disclosure are directed towards polyolefin compositions, useful for films, made with asymmetrical hafnium metallocenes having an n-propyl cyclopentadienyl ligand, processes utilizing the polyolefin compositions, and products made with the compositions.

### FIELD OF DISCLOSURE

Embodiments of the present disclosure are directed towards polyolefin compositions useful for films.

### BACKGROUND

The use of polymers in the formation of films is generally known. Various polymerization techniques using different catalyst systems have been employed to produce such polymers suitable for the formation of such articles. However, there remains a need for compositions that can be used to form films.

### SUMMARY

The present disclosure provides various embodiments, including, without limitation, the following.

A polyolefin composition, wherein the polyolefin composition has a density from 0.910 to 0.945 g/cm³; a melt index (I₂) from 0.1 to 10; a melt flow ratio (I₁₀/I₂) from 10 to 20; a melt flow ratio (I₂₁/I₂) from 15 to 50; a melt strength (190° C.) greater than 8.5 cN; a molecular weight distribution (Mw/Mn) from 2.5 to 5.0; and a reverse comonomer distribution.

### DETAILED DESCRIPTION

Films are known articles that can be made utilizing a polymer. Polyolefin compositions that are useful for making films are discussed herein. For film applications, it can be desirable for the polymer to have a number of properties, e.g., a reverse comonomer distribution and a number of processing attributes.

Advantageously, the present disclosure provides a unimodal polyolefin composition with a reverse comonomer distribution and one or more desirable processability parameters, as compared to other compositions utilized for films. The polyolefin compositions disclosed herein can provide that films therewith have desirable functional, durability, safety, and/or aesthetic qualities that are sought after for various applications.

The polyolefin compositions discussed herein are made with asymmetrical hafnium metallocenes having an n-propyl cyclopentadienyl ligand. These polyolefin compositions can have a number of desirable properties, such as having a reverse comonomer distribution (defined when the MWCDI>0). Further these polyolefin compositions can have one or more desirable processability parameters, e.g., that are desirable for films.

The asymmetrical hafnium metallocenes having an n-propyl cyclopentadienyl ligand can be represented by structure (I):

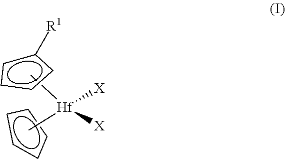

wherein: R¹ is n-propyl, and each X is independently a leaving group. As shown in structure (I), the upper cyclopentadienyl ring is substituted with the R¹ group, and the lower cyclopentadienyl ring is unsubstituted. As one cyclopentadienyl ring is substituted with the R¹ group and the other cyclopentadienyl ring is unsubstituted, the metallocenes can be referred to as asymmetrical hafnium metallocenes.

Embodiments of the present disclosure provide that X is a leaving group. One or more embodiments provide that X is selected from alkyls, aryls, hydridos, and halogens. One or more embodiments provide that X is selected from a halogen, (C₁-C₅)alkyl, CH₂SiMe₃, and benzyl. One or more embodiments provide that X is selected from alkyls and halogens. One or more embodiments provide that X is Cl. One or more embodiments provide that X is methyl.

Examples of X include halogen ions, hydrides, (C₁ to C₁₂)alkyls, (C₂ to C₁₂)alkenyls, (C₆ to C₁₂)aryls, (C₇ to C₂₀)alkylaryls, (C₁ to C₁₂)alkoxys, (C₆ to C₁₆)aryloxys, (C₇ to C₈)alkylaryloxys, (C₁ to C₁₂)fluoroalkyls, (C₆ to C₁₂)fluoroaryls, and (C₁ to C₁₂)heteroatom-containing hydrocarbons and substituted derivatives thereof; one or more embodiments include hydrides, halogen ions, (C₁ to C₆)alkyls, (C₂ to C₆) alkenyls, (C₇ to C₁₈)alkylaryls, (C₁ to C₆)alkoxys, (C₆ to C₁₄)aryloxys, (C₇ to C₁₆) alkylaryloxys, (C₁ to C₆)alkylcarboxylates, (C₁ to C₆)fluorinated alkylcarboxylates, (C₆ to C₁₂) arylcarboxylates, (C₇ to C₁₈)alkylarylcarboxylates, (C₁ to C₆) fluoroalkyls, (C₂ to C₆) fluoroalkenyls, and (C₇ to C₁₈)fluoroalkylaryls; one or more embodiments include hydride, chloride, fluoride, methyl, phenyl, phenoxy, benzoxy, tosyl, fluoromethyls and fluorophenyls; one or more embodiments include (C₁ to C₁₂)alkyls, (C₂ to C₁₂)alkenyls, (C₆ to C₁₂)aryls, (C₇ to C₂₀)alkylaryls, substituted (C₁ to C₁₂)alkyls, substituted (C₆ to C₁₂)aryls, substituted (C₇ to C₂₀)alkylaryls, and (C₁ to C₁₂)heteroatom-containing alkyls, (C₁ to C₁₂)heteroatom-containing aryls, and (C₁ to C₁₂)heteroatom-containing alkylaryls; one or more embodiments include chloride, fluoride, (C₁ to C₆)alkyls, (C₂ to C₆)alkenyls, (C₇ to C₁₈)alkylaryls, halogenated (C₁ to C₆)alkyls, halogenated (C₂ to C₆)alkenyls, and halogenated (C₇ to C₁₈)alkylaryls; one or more embodiments include fluoride, methyl, ethyl, propyl, phenyl, methylphenyl, dimethylphenyl, trimethylphenyl, fluoromethyls (mono-, di- and trifluoromethyls) and fluorophenyls (mono-, di-, tri-, tetra- and pentafluorophenyls).

Other non-limiting examples of X groups include amines, phosphines, ethers, carboxylates, dienes, hydrocarbon radicals having from 1 to 20 carbon atoms, fluorinated hydrocarbon radicals, e.g., —C₆F₅ (pentafluorophenyl), fluorinated alkylcarboxylates, e.g., CF₃C(O)O—, hydrides, halogen ions and combinations thereof. Other examples of X ligands include alkyl groups such as cyclobutyl, cyclohexyl, methyl, heptyl, tolyl, trifluoromethyl, tetramethylene, pentamethylene, methylidene, methyoxy, ethyoxy, propoxy, phenoxy, bis(N-methylanilide), dimethylamide, and dimethylphosphide radicals, among others. In one embodiment, two or more X's form a part of a fused ring or ring system. In one or more embodiments, X can be a leaving group selected from the group consisting of chloride ions, bromide ions, (C₁ to C₁₀)alkyls, (C₂ to C₁₂)alkenyls, carboxylates, acetylacetonates, and alkoxides. In one or more embodiments, X is methyl.

The asymmetrical hafnium metallocenes having an n-propyl cyclopentadienyl ligand discussed herein can be made by contacting a hafnium complex with an alkali metal complex to make the asymmetrical hafnium metallocenes having an n-propyl cyclopentadienyl ligand. The asymmetrical hafnium metallocenes having an n-propyl cyclopentadienyl ligand discussed herein can be made by processes, e.g., with conventional solvents, reaction conditions, reaction times, and isolation procedures, utilized for making known metallocenes.

The alkali metal complex can be represented by one of the following structures:

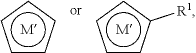

wherein M′ is lithium, sodium, or potassium and R¹ is n-propyl.

One or more embodiments provide that the hafnium complex can be represented by one the following structures:

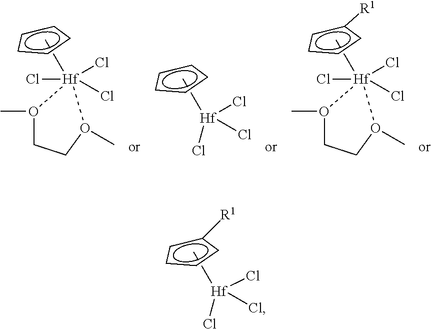

wherein R¹ is n-propyl.

One or more embodiments provide that making the asymmetrical hafnium metallocenes having an n-propyl cyclopentadienyl ligand, e.g., where each X is Cl, comprises contacting the asymmetrical hafnium metallocenes having an n-propyl cyclopentadienyl ligand with two mole equivalents of an organomagnesium halide of formula RMg(halide) or one mole equivalent of R₂Mg, wherein R is (C₁-C₅)alkyl, CH₂SiMe₃, or benzyl; and the halide is Cl or Br, to make the asymmetrical hafnium metallocenes having an n-propyl cyclopentadienyl ligand of structure (I) wherein each X is a (C₁-C₅)alkyl, CH₂SiMe₃, or benzyl. One or more embodiments provide X is a (C₁-C₅)alkyl, CH₂SiMe₃, or benzyl. As used herein, all reference to the Periodic Table of the Elements and groups thereof is to the NEW NOTATION published in HAWLEY'S CONDENSED CHEMICAL DICTIONARY, Thirteenth Edition, John Wiley & Sons, Inc., (1997) (reproduced there with permission from IUPAC), unless reference is made to the Previous IUPAC form noted with Roman numerals (also appearing in the same), or unless otherwise noted.

As used herein, an “alkyl” includes linear, branched and cyclic paraffin radicals that are deficient by one hydrogen. Thus, for example, CH₃ (“methyl”) and CH₂CH₃ (“ethyl”) are examples of alkyls.

As used herein, an “alkenyl” includes linear, branched and cyclic olefin radicals that are deficient by one hydrogen; alkynyl radicals include linear, branched and cyclic acetylene radicals deficient by one hydrogen radical.

As used herein, “aryl” groups include phenyl, naphthyl, pyridyl and other radicals whose molecules have the ring structure characteristic of benzene, naphthylene, phenanthrene, anthracene, etc. It is understood that an “aryl’ group can be a C₆ to C₂₀ aryl group. For example, a C₆H₅ aromatic structure is an “phenyl”, a C₆H₄ 2 aromatic structure is an “phenylene”. An “arylalkyl” group is an alkyl group having an aryl group pendant therefrom. It is understood that an “aralkyl” group can be a (C₇ to C₂₀ aralkyl group. An “alkylaryl” is an aryl group having one or more alkyl groups pendant therefrom.

As used herein, an “alkylene” includes linear, branched and cyclic hydrocarbon radicals deficient by two hydrogens. Thus, CH₂ (“methylene”) and CH₂CH₂ (“ethylene”) are examples of alkylene groups. Other groups deficient by two hydrogen radicals include “arylene” and “alkenylene”.

As used herein, the term “heteroatom” includes any atom selected from the group consisting of B, Al, Si, Ge, N, P, O, and S. A “heteroatom-containing group” is a hydrocarbon radical that contains a heteroatom and may contain one or more of the same or different heteroatoms, and from 1 to 3 heteroatoms in a particular embodiment. Non-limiting examples of heteroatom-containing groups include radicals (monoradicals and diradicals) of imines, amines, oxides, phosphines, ethers, ketones, oxoazolines heterocyclics, oxazolines, and thioethers.

As used herein, the term “substituted” means that one or more hydrogen atoms in a parent structure has been independently replaced by a substituent atom or group.

The asymmetrical hafnium metallocenes having an n-propyl cyclopentadienyl ligand discussed herein can be utilized to make catalyst compositions. These compositions include the asymmetrical hafnium metallocenes discussed herein and an activator. The asymmetrical hafnium metallocenes discussed herein and the activator can be contacted to make a catalyst composition. One or more embodiments provide that the activator is an alkylaluminoxane such as methylaluminoxane. As used herein, “activator” refers to any compound or combination of compounds, supported, or unsupported, which can activate a complex or a catalyst component, such as by creating a cationic species of the catalyst component. For example, this can include the abstraction of at least one leaving group, e.g., the “X” groups described herein, from the metal center of the complex/catalyst component, e.g., the asymmetrical hafnium metallocene having an n-propyl cyclopentadienyl ligand of Structure (I). The activator may also be referred to as a “co-catalyst”. As used herein, “leaving group” refers to one or more chemical moieties bound to a metal atom and that can be abstracted by an activator, thus producing a species active towards olefin polymerization. Various catalyst compositions, e.g., olefin polymerization catalyst compositions, are known in the art and different known catalyst composition components may be utilized. Various amounts of known catalyst composition components may be utilized for different applications.

The asymmetrical hafnium metallocenes having an n-propyl cyclopentadienyl ligand discussed herein can be utilized to make spray-dried compositions. As used herein, “spray-dried composition” refers to a composition that includes a number of components that have undergone a spray-drying process. Various spray-drying process are known in the art and are suitable for forming the spray-dried compositions disclosed herein. One or more embodiments provide that the spray-dried composition comprises a trim composition.

In one or more embodiments, the spray-drying process may comprise atomizing a composition including the asymmetrical hafnium metallocene having an n-propyl cyclopentadienyl ligand discussed herein. A number of other known components may be utilized in the spray-drying process. An atomizer, such as an atomizing nozzle or a centrifugal high speed disc, for example, may be used to create a spray or dispersion of droplets of the composition. The droplets of the composition may then be rapidly dried by contact with an inert drying gas. The inert drying gas may be any gas that is non-reactive under the conditions employed during atomization, such as nitrogen, for example. The inert drying gas may meet the composition at the atomizer, which produces a droplet stream on a continuous basis. Dried particles of the composition may be trapped out of the process in a separator, such as a cyclone, for example, which can separate solids formed from a gaseous mixture of the drying gas, solvent, and other volatile components.

A spray-dried composition may have the form of a free-flowing powder, for instance. After the spray-drying process, the spray-dried composition and a number of known components may be utilized to form a slurry. The spray-dried composition may be utilized with a diluent to form a slurry suitable for use in olefin polymerization, for example. In one or more embodiments, the slurry may be combined with one or more additional catalysts or other known components prior to delivery into a polymerization reactor.

In one or more embodiments, the spray-dried composition may be formed by contacting a spray dried activator particle, such as spray dried MAO, with a solution of the asymmetrical hafnium metallocene having an n-propyl cyclopentadienyl ligand discussed herein. Such a solution typically may be made in an inert hydrocarbon solvent, for instance, and is sometimes called a trim solution. Such a spray-dried composition comprised of contacting a trim solution of the asymmetrical hafnium metallocene having an n-propyl cyclopentadienyl ligand with a spray dried activator particle, such as spray-dried MAO, may be made in situ in a feed line heading into a gas phase polymerization reactor by contacting the trim solution with a slurry, typically in mineral oil, of the spray-dried activator particle.

Various spray-drying conditions may be utilized for different applications. For instance, the spray-drying process may utilize a drying temperature from 75 to 185° C. Other drying temperatures are possible, where the temperature can depend on the metallocene and activator particle. Various sizes of orifices of the atomizing nozzle employed during the spray-drying process may be utilized to obtain different particle sizes. Alternatively, for other types of atomizers such as discs, rotational speed, disc size, and number/size of holes may be adjusted to obtain different particle sizes. One or more embodiments provide that a filler may be utilized in the spray-drying process. Different fillers and amounts thereof may be utilized for various applications.

The asymmetrical hafnium metallocenes having an n-propyl cyclopentadienyl ligand discussed herein, such as the spray-dried hafnium metallocene composition, may be utilized to make a polymer. For instance, the asymmetrical hafnium metallocene having an n-propyl cyclopentadienyl ligand may be activated, i.e., with an activator, to make a catalyst. One or more embodiments provide that the spray-dried compositions include an activator. As used herein, “activator” refers to any compound or combination of compounds, supported, or unsupported, which can activate a complex or a catalyst component, such as by creating a cationic species of the catalyst component, e.g., to provide the catalyst. The activator may also be referred to as a “co-catalyst”. The activator can include a Lewis acid or a non-coordinating ionic activator or ionizing activator, or any other compound including Lewis bases, aluminum alkyls, and/or conventional-type co-catalysts. Activators include methylaluminoxane (MAO) and modified methylaluminoxane (MMAO), among others. One or more embodiments provide that the activator is methylaluminoxane. Activating conditions are well known in the art. Known activating conditions may be utilized.

A molar ratio of metal, e.g., aluminum, in the activator to hafnium in the asymmetrical hafnium metallocene having an n-propyl cyclopentadienyl ligand may be 1500:1 to 0.5:1, 300:1 to 1:1, or 150:1 to 1:1. One or more embodiments provide that the molar ratio of in the activator to hafnium in the asymmetrical hafnium metallocene having an n-propyl cyclopentadienyl ligand is at least 75:1. One or more embodiments provide that the molar ratio of in the activator to hafnium in the asymmetrical hafnium metallocene having an n-propyl cyclopentadienyl ligand is at least 100:1. One or more embodiments provide that the molar ratio of in the activator to hafnium in the asymmetrical hafnium metallocene having an n-propyl cyclopentadienyl ligand is at least 150:1.

The asymmetrical hafnium metallocenes having an n-propyl cyclopentadienyl ligand discussed herein, as well as a number of other components, can be supported on the same or separate supports, or one or more of the components may be used in an unsupported form. Utilizing the support may be accomplished by any technique used in the art. One or more embodiments provide that the spray-dry process is utilized. The support may be functionalized. One or more embodiments provide that the spray-dried compositions include a support.

A “support”, which may also be referred to as a “carrier”, refers to any support material, including a porous support material, such as talc, inorganic oxides, and inorganic chlorides. Other support materials include resinous support materials, e.g., polystyrene, functionalized or crosslinked organic supports, such as polystyrene divinyl benzene polyolefins or polymeric compounds, zeolites, clays, or any other organic or inorganic support material and the like, or mixtures thereof.

Support materials include inorganic oxides that include Group 2, 3, 4, 5, 13 or 14 metal oxides. Some preferred supports include silica, fumed silica, alumina, silica-alumina, and mixtures thereof. Some other supports include magnesia, titania, zirconia, magnesium chloride, montmorillonite, phyllosilicate, zeolites, talc, clays, and the like. Also, combinations of these support materials may be used, for example, silica-chromium, silica-alumina, silica-titania and the like. One or more embodiments provide that the support is silica, One or more embodiments provide that the support is hydrophobic fumed silica. One or more embodiments provide that the support is dehydrated silica. Additional support materials may include porous acrylic polymers, nanocomposites, aerogels, spherulites, and polymeric beads. An example of a support is fumed silica available under the trade name Cabosil™ TS-610, or other TS- or TG-series supports, available from Cabot Corporation. Fumed silica is typically a silica with particles 7 to 30 nanometers in size that has been treated with dimethylsilyldichloride such that a majority of the surface hydroxyl groups are capped.

The asymmetrical hafnium metallocenes having an n-propyl cyclopentadienyl ligand discussed herein, e.g., compositions/catalyst compositions/spray-dried compositions, and an olefin can be contacted under polymerization conditions to make a polymer, e.g., a polyolefin polymer. The polymerization process may be a solution polymerization process, a suspension polymerization process, a slurry polymerization process, and/or a gas phase polymerization process. The polymerization process may utilize using known equipment and reaction conditions, e.g., known polymerization conditions. The polymerization process is not limited to any specific type of polymerization system. The polymer can be utilized for a number of articles, such as films.

One or more embodiments provide that the polymers are made utilizing a gas-phase reactor system. One or more embodiments provide that a single gas-phase reactor, e.g., in contrast to a series of reactors, is utilized. In other words, polymerization reaction occurs in only one reactor. For instance, the polymers can be made utilizing a fluidized bed reactor. Gas-phase reactors are known and known components may be utilized for the fluidized bed reactor.

As used herein an “olefin,” which may be referred to as an “alkene,” refers to a linear, branched, or cyclic compound including carbon and hydrogen and having at least one double bond. As used herein, when a polyolefin, polymer, and/or copolymer is referred to as comprising, e.g., being made from, an olefin, the olefin present in such polymer or copolymer is the polymerized form of the olefin. For example, when a copolymer is said to have an ethylene content of 75 wt % to 95 wt %, it is understood that the polymer unit in the copolymer is derived from ethylene in the polymerization reaction(s) and the derived units are present at 75 wt % to 95 wt %, based upon the total weight of the polymer. A higher α-olefin refers to an α-olefin having 3 or more carbon atoms.

Polyolefins made with the compositions discussed herein can be made from olefin monomers such as ethylene (i.e., polyethylene), or propylene (i.e., polypropylene), among other provided herein, where the polyolefin is a homopolymer made only from the olefin monomer (e.g., made with 100 wt. % ethylene or 100 wt. % propylene). Alternatively, polyolefin compositions discussed herein can made from olefin monomers such as ethylene, i.e., polyethylene, and linear or branched higher alpha-olefin monomers containing 3 to 20 carbon atoms. Examples of higher alpha-olefin monomers include, but are not limited to, propylene, butene, pentene, 1-hexene, and 1-octene. Examples of polyolefins include ethylene-based polymers, having at least 50 wt % ethylene, including ethylene-1-butene, ethylene-1-hexene, and ethylene-1-octene copolymers, among others. One or more embodiments provide that the polymer can include from 50 to 99.9 wt % of units derived from ethylene based on a total weight of the polymer. All individual values and subranges from 50 to 99.9 wt % are included; for example, the polymer can include from a lower limit of 50, 60, 70, 80, or 90 wt % of units derived from ethylene to an upper limit of 99.9, 99.7, 99.4, 99, 96, 93, 90, or 85 wt % of units derived from ethylene based on the total weight of the polymer. The polymer can include from 0.1 to 50 wt % of units derived from comonomer based on the total weight of the polymer. One or more embodiments provide that ethylene is utilized as a monomer and hexene is utilized as a comonomer.

As mentioned, the polymers made with the compositions disclosed herein can be made in a fluidized bed reactor. The fluidized bed reactor can have a reaction temperature from 10 to 130° C. All individual values and subranges from 10 to 130° C. are included; for example, the fluidized bed reactor can have a reaction temperature from a lower limit of 10, 20, 30, 40, 50, or 55° C. to an upper limit of 130, 120, 110, 100, 90, 80, 70, or 60° C.

The fluidized bed reactor can have an ethylene partial pressure from 30 to 250 pounds per square inch (psi). All individual values and subranges from 30 to 250 are included; for example, the fluidized bed reactor can have an ethylene partial pressure from a lower limit of 30, 45, 60, 75, 85, 90, or 95 psi to an upper limit of 250, 240, 220, 200, 150, or 125 psi.

One or more embodiments provide that ethylene is utilized as a monomer and hexene is utilized as a comonomer. The fluidized bed reactor can have a comonomer to ethylene mole ratio, e.g., C₆/C₂, from 0.0001 to 0.100. All individual values and subranges from 0.0001 to 0.100 are included; for example, the fluidized bed reactor can have a comonomer to ethylene mole ratio from a lower limit of 0.0001, 0.0005, 0.0007, 0.001, 0.0015, 0.002, 0.007, or 0.010 to an upper limit of 0.100, 0.080, 0.050, 0.025, or 0.20.

When hydrogen is utilized for a polymerization process, the fluidized bed reactor can have a hydrogen to ethylene mole ratio (H₂/C₂) from 0.00001 to 0.90000, for instance. All individual values and subranges from 0.00001 to 0.90000 are included; for example, the fluidized bed reactor can have a H₂/C₂ from a lower limit of 0.00001, 0.00005, or 0.00008 to an upper limit of 0.90000, 0.500000, 0.10000, 0.01500, 0.00700, or 0.00500. One or more embodiments provide that hydrogen is not utilized.

Compositional Conventional GPC was determined as follows.

The chromatographic system consisted of a PolymerChar GPC-IR (Valencia, Spain) high temperature GPC chromatograph equipped with an internal IR5 infra-red detector (IR5). The autosampler oven compartment was set at 160° C. and the column compartment was set at 150° C. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 g/mol and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968)):

$${M}_{polyethylene} = A \times {( {M}_{polystyrene} )}^{B} \qquad ( EQ 1 )$$

where M is the molecular weight, A has a value of 0.4138 and B is equal to 1.0.

A fifth order polynomial was used to fit the respective polyethylene-equivalent calibration points.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° C. under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 2-4, using PolymerChar GPCON software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 2 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 3 )$$

$${Mz}_{( GPC )} = \frac{{\sum }^{i} ( {IR}_{i} * {{M}_{{polyethylene}_{i}}}^{2} )}{{\sum }^{i} ( {IR}_{i} * {M}_{{polyethylene}_{i}} )} \qquad ( EQ 4 )$$

To monitor the deviations over time, a flowrate marker (decane) was introduced into each sample via a micropump controlled with the PolymerChar GPC-IR system. This flowrate marker (FM) was used to linearly correct the pump flowrate (Flowrate₍ₙₒₘᵢₙₐₗ₎) for each sample by RV alignment of the respective decane peak within the sample (RV_{(FM Sample)}) to that of the decane peak within the narrow standards calibration (RV_{(FM Calibrated)}). Any changes in the time of the decane marker peak are then assumed to be related to a linear-shift in flowrate (Flowrate (effective)) for the entire run. After calibrating the system based on a flow marker peak, the effective flowrate (with respect to the narrow standards calibration) is calculated as Equation 5. Processing of the flow marker peak was done via the PolymerChar GPCON Software. Acceptable flowrate correction is such that the effective flowrate should be within +/−0.5% of the nominal flowrate.

### Sample))

$$Flowrate ( effective ) = {Flowrate ( nominal )}^{*} ( RV ( FM Calibrated ) / RV ( FM \qquad ( EQ 5 )$$

### IR5 GPC Octene Composition Calibration

A calibration for the IR5 detector rationing was performed using at least ten ethylene-based polymer standards (Octene as comonomer) made by single-site metallocene catalyst from a single reactor in solution process (polyethylene homopolymer and ethylene/octene copolymers) of a narrow SCB distribution and known comonomer content (as measured by ¹³C NMR Method, Qiu et al., Anal. Chem. 2009, 81, 8585-8589), ranging from homopolymer (0 SCB/1000 total C) to approximately 40 SCB/1000 total C, where total C=carbons in backbone+carbons in branches. Each standard had a weight-average molecular weight from 36,000 g/mole to 126,000 g/mole measured by GPC. Each standard had a molecular weight distribution (Mw/Mn) from 2.0 to 2.5. Polymer properties for the SCB standards are shown in Table A.

TABLE A
“Copolymer” Standards

| Wt % | | | | |
|---|---|---|---|---|
| Comonomer | IR5 Area ratio | SCB/1000 Total C | Mw | Mw/Mn |
| 23.1 | 0.2411 | 28.9 | 37,300 | 2.22 |
| 14.0 | 0.2152 | 17.5 | 36,000 | 2.19 |
| 0.0 | 0.1809 | 0.0 | 38,400 | 2.20 |
| 35.9 | 0.2708 | 44.9 | 42,200 | 2.18 |
| 5.4 | 0.1959 | 6.8 | 37,400 | 2.16 |
| 8.6 | 0.2043 | 10.8 | 36,800 | 2.20 |
| 39.2 | 0.2770 | 49.0 | 125,600 | 2.22 |
| 1.1 | 0.1810 | 1.4 | 107,000 | 2.09 |
| 14.3 | 0.2161 | 17.9 | 103,600 | 2.20 |
| 9.4 | 0.2031 | 11.8 | 103,200 | 2.26 |

The “IR5 Area Ratio (or “IR5_{Methyl Channel Area}/IR5_{Measurement Channel Area}”)” Of “the baseline-subtracted area response of the IR5 methyl channel sensor” to “the baseline-subtracted area response of IR5 measurement channel sensor” (standard filters and filter wheel as supplied by PolymerChar: Part Number IR5_FWM01 included as part of the GPC-IR instrument) was calculated for each of the “Copolymer” standards. A linear fit of the Wt % Comonomer frequency versus the “IR5 Area Ratio” was constructed in the form of the following Equation 6:

$$Wt \% Comonomer = {A}_{0} + [ {A}_{1} \times ( IR {5}_{Methyl Channel Area} / IR {5}_{Measurement Channel Area} ) ] \qquad ( EQ 6 )$$

where A₀ is the “Wt % Comonomer” intercept at an “IR5 Area Ratio” of zero, and A₁ is the slope of the “Wt % Comonomer” versus “IR5 Area Ratio” and represents the increase in the Wt % Comonomer as a function of “IR5 Area Ratio.” The IR5 area ratio is equal to the IR5 height ratio for narrow PDI and narrow SCBD standard materials.

The comonomer distribution in an ethylene/α-olefin copolymer can be characterized as either normal (also referred to as having a Zeigler-Natta distribution), reverse, or flat. Several reported methods are utilized to quantify a Broad Orthogonal Composition Distribution (BOCD). Herein, a simple line fit is utilized such that the normal or reverse nature of the comonomer distribution can be quantified by the molecular weight comonomer distribution index (MWCDI), which is the slope of the linear regression of the comonomer distribution taken from a compositional GPC measurement, wherein the x-axis is Log(MW) and the y-axis is weight percent of comonomer. Short chain branching (SCB) was excluded from the MWCDI calculation according to the formula 0.1>(SCBF)*(MW detector response) wherein SCBF is the SCB frequency measured in SCB/1000 C. A reverse comonomer distribution is defined when the MWCDI>0 and a normal comonomer distribution is defined when the MWCDI<0. When the MWCDI=0 the comonomer distribution is said to be flat. Additionally, the MWCDI quantifies the magnitude of the comonomer distribution. Comparing two polymers that have MWCDI>0, the polymer with the greater MWCDI value is defined to have a greater, i.e., increased, BOCD; in other words, the polymer with the greater MWCDI value has a greater reverse comonomer distribution. Polymers with a relatively greater MWCDI, i.e., BOCD, can provide one or more improved physical properties, as compared to polymers having a relatively lesser MWCDI.

The polyolefin compositions disclosed herein can have a short chain branching distribution (SCBD) from 10 to 50. All individual values and subranges from 10 to 50 are included; for example, the hydrogenation-catalyst treated polyethylene can have a SCBD from a lower limit of 10, 12, or 15 to an upper limit of 50, 45, or 40. SCBD may be determined from data obtained from techniques known in the art, such as, for example, temperature rising elution fractionation (abbreviated herein as “TREF”) as described, for example, by Wild et al., Journal of Polymer Science, Poly. Phys. Ed., Vol. 20, p. 441 (1982), or in U.S. Pat. Nos. 4,798,081; 5,008,204; or by L. D. Cady, “The Role of Comonomer Type and Distribution in LLDPE Product Performance,” SPE Regional Technical Conference, Quaker Square Hilton, Akron, Ohio, October 1-2, pp. 107-119 (1985).

The polyolefin compositions disclosed herein are unimodal, e.g., in contrast to bimodal. As used herein, “unimodal” refers to polymers that can be characterized by having one peak in a GPC chromatogram showing the molecular weight distribution. Furthermore, a unimodal composition is a composition that is made by utilizing a single catalyst, e.g., a single polyethylene catalyst, in a single reactor. This distinguishes the unimodal composition, as defined above, from bimodal compositions that may appear to have one peak in the GPC chromatogram showing the molecular weight distribution. These bimodal compositions are those that are made by one or more polyethylene catalysts in a staged reactor process, typically a dual reactor process including but not limited to two solution PE reactors, or two gas phase polymer reactors, or two slurry phase polymerization reactors, or combinations thereof such as a sequential slurry and gas phase reactors, such that two different polymers of different densities, and optionally molecular weights are made in the different reactors. The two or more reactors may be in series or parallel or some combination thereof. These approaches can provide an improved MWCDI compared to what the individual PE catalyst or catalysts can achieve independently. In the case where the MW of two components of the bimodal are similar enough the polymer may appear to have a single peak in a GPC chromatogram. As this composition required at least two reactors and one or more PE catalysts this is defined as a bimodal composition. Additionally, two or more PE catalysts in a single solution, slurry, or gas phase reactor may produce such a bimodal polymer as described above that appears to have a single peak in a GPC chromatogram showing the molecular weight distribution. This would also be defined as a bimodal polymer composition.

The polyolefin compositions disclosed herein can have a MWCDI from 0.10 to 10.00. All individual values and subranges from 0.10 to 10.00 are included; for example, the polyolefin composition can have a MWCDI from a lower limit of 0.10, 0.50, or 1.00 to an upper limit of 10.00, 9.00, 8.00, 8.50, or 8.35.

The polyolefin compositions disclosed herein can have a density from 0.910 to 0.945 g/cm³. All individual values and subranges from 0.910 to 0.945 g/cm³ are included; for example, the polyolefin composition can have a density from a lower limit of 0.910, 0.915, or 0.920 g/cm³ to an upper limit of 0.945, 0.940, 0.935, or 0.930 g/cm³. Density can be determined by according to ASTM D792. One or more embodiments provide that the polyolefin composition is linear low-density polyethylene (LLDPE).

The polyolefin compositions disclosed herein can have a melt index (I₂) from 0.1 to 10 dg/min. I₂ can be determined according to ASTM D1238 (190° C., 2.16 kg). All individual values and subranges from 0.1 to 10 dg/min are included; for example, the polyolefin composition can have an I₂ from a lower limit of 0.1, 0.15, or 0.2 dg/min to an upper limit of 10, 7, 5, or 3 dg/min.

The polyolefin compositions disclosed herein can have a flow index (I₂₁) from 3 to 250 dg/min. I₂₁ can be determined according to ASTM D1238 (190° C., 21.6 kg). All individual values and subranges from 3 to 250 dg/min are included; for example, the polyolefin composition can have an I₂₁ from a lower limit of 3, 4, or 5 dg/min to an upper limit of 250, 225, 200, or 100 dg/min.

The polyolefin compositions disclosed herein can have a melt flow ratio (I₂₁/I₂) from 15 to 50. All individual values and subranges from 15 to 50 are included; for example, the polyolefin composition can have an I₂₁/I₂ from a lower limit of 15, 20, 25, 30, 33, or 35 to an upper limit of 50, 45, or 40. One or more embodiments provide that the polyolefin composition can have an I₂₁/I₂ from 30 to 50.

The polyolefin compositions disclosed herein can have a melt flow ratio (I₁₀/I₂) from 10 to 20. All individual values and subranges from 10 to 20 are included; for example, the polyolefin composition can have an I₁₀/I₂ from a lower limit of 10 to an upper limit of 20, 18, or 15. I₁₀ can be determined according to ASTM D1238 (190° C., 10 kg).

The polyolefin compositions disclosed herein can have a weight average molecular weight (Mw) from 100,000 to 300,000 g/mol. All individual values and subranges from 100,000 to 300,000 g/mol are included; for example, the polyolefin composition can have an Mw from a lower limit of 100,000, 120,000 or 130,000 g/mol to an upper limit of 300,000, 250,000, or 200,000 g/mol. Mw can be determined by gel permeation chromatography (GPC), as is known in the art. GPC is discussed herein.

The polyolefin compositions disclosed herein can have a number average molecular weight (Mn) from 20,000 to 100,000 g/mol. All individual values and subranges from 20,000 to 100,000 g/mol are included; for example, the polyolefin composition can have an Mn from a lower limit of 20,000, 25,00, or 30,000 g/mol to an upper limit of 100,000, 75,000 or 50,000 g/mol. Mn can be determined by GPC.

The polyolefin compositions disclosed herein can have a Z-average molecular weight (Mz) from 300,000 to 1,000,000 g/mol. All individual values and subranges from 300,000 to 1,000,000 g/mol are included; for example, the polyolefin composition can have an Mz from a lower limit of 300,000, 350,000, or 400,000 g/mol to an upper limit of 1,000,000, 900,000, or 700,000 g/mol. Mz can be determined by GPC.

The polyolefin compositions disclosed herein can have a weight average molecular weight to number average molecular weight ratio (Mw/Mn) from 2.5 to 5.0. All individual values and subranges from 2.5 to 5.0 are included; for example, the polyolefin composition can have an Mw/Mn from a lower limit of 2.5, 3.0, or 3.5 to an upper limit of 5.0, 4.5, or 4.0 Mw/Mn may also be referred to as molecular weight distribution or “MWD”.

Melt strength can be determined by a Melt Strength Measurement process, as described as follows.

Melt strength was determined with a Göttfert Rheotens unit model 71.9 in combination with a capillary rheometer (such as Rheotester 2000 from Göttfert). A polymer melt (approximately 20-30 grams, pellets) was extruded through a capillary die with a flat entrance angle (180 degrees) with a capillary diameter of 2.0 mm and an aspect ratio (capillary length/capillary diameter) of 15. After equilibrating the samples at 190° C. for 10 minutes, molten polymer was extruded out of the die at a constant volume flow rate corresponding to a theoretical average exit velocity of 9.5 mm/s and an apparent wall shear rate of 38.2 s⁻¹. The wheels of the Rheotens were at approximately 20° C. The distance between the die exit and the wheels was 100 mm. The extruded strand was drawn by a set of standard smooth wheels with a 0.4 mm gap. The wheels were accelerated at a rate of 2.4 mm/s² and the tensile force recorded as a function of take-up speed until the filament broke. The velocity at break is a measure for the drawability of the polymer melt. Melt strength is defined as the plateau value of the force-velocity curve just before the strand broke.

The polyolefin compositions can have a melt strength (190° C.), as determined by the Melt Strength Measurement process described herein, greater than 8.5. For example, the polyolefin compositions can have a melt strength (190° C.) from 10 to 20 (190° C.) centinewtons (cN). All individual values and subranges from 10 to 20 cN are included; for example, the polyolefin composition can have a melt strength (190° C.) from a lower limit of 10, 11, or 12 cN to an upper limit of 20, 19, or 18 cN.

The polyolefin compositions disclosed herein can be utilized to provide a film dart impact from 700 to 1200 grams. All individual values and subranges from 700 to 1200 grams are included; for example, the polyolefin composition can be utilized to provide a film dart impact from a lower limit of 700, 800, or 900 grams to an upper limit of 1200, 1100, or 1000 grams. Film dart can be determined according to ASTM D1709 (when the polyolefin composition is formed into a monolayer blown film having a thickness of 1.5 mil).

Film Fabrication was performed as follows.

Monolayer films were made on a Collin blown film line equipped with a die of 9.42 inch diameter and 80 mil die gap. A blow-up ratio of 1.5 was used. Film thickness was maintained at 2 mil. Extruder melt temperature was set at 225° C. Output rate was 10 lb/hr.

Instrumented Dart Impact was determined as follows.

Prior to testing the samples are conditioned for a minimum of 40 hrs at 23 (+/−2° C.) and 50 (+/−10) % R.H. per ASTM D618 (Procedure A). Instrumented dart impact is measured on a 6-inch×6-inch square sample. The IDI dart test is based on ASTM D7192. The thickness of the film is measured at the sample center and the film is then clamped to give a 3-inch diameter unsupported test region. The film is struck by an impactor at the specimen center and perpendicular to the plane of the film. The impactor consists of a stainless-steel plunger rod 12.7+/−0.13 mm in diameter with a hemispherical end of the same diameter, with the end polished to a mirror finish. The impactor strikes the film specimen at 3.3 m/s with sufficient energy such that at the end of the test the reduction in speed is less than 20%. From the force versus displacement curves, peak force, energy to peak force, displacement at peak force and total displacement, and total energy are reported. Ten replicates are measured, and the average and standard deviation of the results determined.

Film Gloss was determined according to ASTM D2457.

Film gloss is measured hand-held BYK Micro-gloss meters to according to ASTM D2457. Gloss angles of 20°, 45°, 60° and 80° are available. The film is conditioned for at least 40 hours after film production at 23° C. (+/−2° C.) and 50% R.H (+/−10) as per ASTM standards. Standard testing conditions are 23° C. (+/−2° C.) and 50% R.H (+/−10) as per ASTM standards. An internal calibration is run on the meter prior to testing. Further, an SQC standard is run prior to sample testing to ensure the machine is reading correctly. Specimens of film of approximately 6″×6″ are cut from the sheet and placed on a plastic ring, The specimen is then clamped on the inside of the ring using spring loaded circular metallic clamp. This puts a slight tension on the film and helps to ensure there are no wrinkles/folds on the specimen. For rigid samples, ensure consistency in the sample geometry (side, position, direction etc.). The specimen is placed on a black background and a meter of the requested geometry placed on the specimen and a reading taken. Five (5) replicates are measured per sample.

Secant Modulus was determined according to ASTM D882.

Tensile tests measure the properties of a film when tested under uniaxial extension. The secant modulus is measured at a specified strain and is the ratio of the stress at the specified strain to the specified strain, as determined from the load-extension curve.

The film is conditioned for at least 40 hours after film production at 23° C. (+/−2° C.) and 50% R.H (+/−10%) as per ASTM standards. Standard testing conditions are 23° C. (+/−2° C.) and 50% R.H (+/−10%) as per ASTM standards.

One inch wide test strips are loaded in a tensile testing frame using line contact grips at a contact point (gauge length) separation of 4 inches. Samples are tested at a crosshead speed of 2 inches/min up to a nominal stain of 5%. The elastic modulus (from the initial portion of the stress-strain curve, often referred to as the Young's Modulus) and secant modulus at 1% and 2% strain are calculated.

Tensile properties were determined as follows.

Prior to testing the samples are conditioned for a minimum of 40 hrs at 23 (+/−2° C.) and 50 (+/−10) % R.H. per ASTM D618 (Procedure A). The tensile test procedure is based on ASTM D882. Tensile strips of 1″ width are cut from the sheet in (if applicable) the machine or cross direction (MD, CD). Prior to testing, the thickness of a specimen is measured at the middle of the specimen. They are then loaded into the testing frame and held using line grip jaws (flat rubber on one side of the jaw and a line grip the other). The jaws are set at a gauge length (line grip to line grip distance) of 2 inches. The samples are then strained at a crosshead speed of 20 inches/min. From the resulting load-displacement (stress-strain) curve the yield strength and yield strain, tensile strength and tensile strength at break, strain at break and energy to break can be determined. Twelve replicates are measured, and the average and standard deviation of the measured values is determined.

Dart Drop was determined according to ASTM D1709.

The Dart Drop test determines the energy that causes plastic film to fail under specified conditions of impact by a free-falling dart. The test result is the energy expressed in terms of the weight of the missile falling from a specified height, that would result in failure of 50% of the specimens tested.

The film is conditioned for at least 40 hours after film production at 23° C. (+/−2° C.) and 50% R.H (+/−10) as per ASTM standards. Standard testing conditions are 23° C. (+/−2° C.) and 50% R.H (+/−10) as per ASTM standards.

Method A uses a 1.5 inch diameter dart head and 26 inch drop height. The sample thickness is measured at the sample center and the sample then clamped by an annular specimen holder with an inside diameter of 5 inches. The dart is loaded above the center of the sample and released by either a pneumatic or electromagnetic mechanism.

Testing is carried out according to the ‘staircase’ method. If the sample fails, a new sample is tested with the weight of the dart reduced by a known and fixed amount. If the sample does not fail, a new sample is tested with the weight of the dart increased by a known increment. After 20 specimens have been tested the number of failures is determined. If this number is 10 then the test is complete. If the number is less than 10 the testing continues until 10 failures have been recorded. If the number is greater than 10, testing is continued until the total of non-failures is 10. The Dart drop strength is determined from these data as per ASTM D1709.

Puncture Resistance is determined according to ASTM D5748.

The Puncture test determines the resistance of a film to the penetration of a probe at a standard low rate, single test velocity.

The film is conditioned for at least 40 hours after film production at 23° C. (+/−2° C.) and 50% R.H (+/−10) as per ASTM standards. Standard testing conditions are 23° C. (+/−2° C.) and 50% R.H (+/−10) as per ASTM standards.

Puncture is measured on a tensile testing machine. Square specimens are cut from a sheet to a size of approximately 6 inches by 6 inches. The specimen is clamped in a 4 inch diameter circular specimen holder and a puncture probe is pushed into the center of the clamped film at a cross head speed of 10 inches/minute. Herein, puncture utilizes a probe that is a 0.5 inch diameter polished steel ball on a 0.25 inch diameter support rod option, which deviates from the ASTM standard in that the ASTM probe uses the 0.75 inch diameter, pear shaped Teflon coated probe specified in D5748. There is an approximate 12 inch maximum travel length to prevent damage to the test fixture. There is no gauge length; prior to testing the probe is as close as possible to, but not touching, the specimen. A single thickness measurement is made in the center of the specimen. For each specimen, the maximum force, force at break, penetration distance, energy to break and puncture strength (energy per unit volume of the sample) is determined. A total of 5 specimens are tested to determine an average puncture value. The puncture probe is cleaned using a “Kim-wipe” after each specimen.

Elmendorf Tear is determined according to ASTM D1922.

The Elmendorf Tear test determines an average force to propagate tearing through a specified length of plastic film or nonrigid sheeting after the tear has been started using an Elmendorf-type tearing tester.

The film is conditioned for at least 40 hours after film production at 23° C. (+/−2° C.) and 50% R.H (+/−10) as per ASTM standards. Standard testing conditions are 23° C. (+/−2° C.) and 50% R.H (+/−10) as per ASTM standards.

The force in grams required to propagate tearing across a film or sheeting specimen is measured using a precisely calibrated pendulum device. Acting by gravity, the pendulum swings through an arc, tearing the specimen from a precut slit. The specimen is held on one side by the pendulum and on the other side by a stationary member. The loss in energy by the pendulum is indicated by a pointer or by an electronic scale. The scale indication is a function of the force required to tear the specimen. The sample used is the ‘constant radius geometry’ as specified in D1922. Testing would be typically carried out on samples that have been cut from both the MD and CD directions. Prior to testing, the sample thickness is measured at the sample center. A total of 15 specimens per direction are tested and average tear strength is determined.

The complex viscosities of the polyolefin compositions can be obtained via the Complex Viscosity Measurement process, described as follows. Rheological properties can be determined from 0.1 to 100 radians/second (rad/s) in a nitrogen environment at 190° C. and a strain amplitude of 10% in an ARES-G2 Advanced Rheometric Expansion System (TA Instrument) rheometer oven that is preheated for at least 30 minutes at 190° C. The disk, prepared by the Compression Molded Plaque Preparation Method (wherein resins are compression molded into circular plaques (3 mm thick×1 inch) at 350° F. for 5 minutes under 25000 psi pressure in air. Then the samples are taken out of the press to cool at room temperature), can be placed between two “25 mm” parallel plates in the oven. The gap can be slowly reduced between the “25 mm” parallel plates to 2.0 mm. The sample can remain for 5 minutes at these conditions. Then, the oven can be opened, and excess sample from around the edge of the plates can be trimmed. The oven can be closed and an additional five-minute delay can be used to allow for temperature equilibrium. Then, the complex viscosity can be determined via a small amplitude, oscillatory shear, according to an increasing frequency sweep from 0.1 to 100 rad/s to obtain the complex viscosities between 0.1 rad/s and 100 rad/s.

The polyolefin compositions disclosed herein can be utilized to provide a complex viscosity at 100 rad/s (190° C.) from 2500 to 3900 Pa*s.

The polymers made with the compositions disclosed herein can advantageously, e.g., due to providing a reverse comonomer distribution and desirable processing attributes, be utilized for films. Making the films can be performed with known equipment and known conditions.

A number of aspects of the present disclosure are provided as follows.

Aspect 1 provides a polyolefin composition, wherein the polyolefin composition has: a density from 0.910 to 0.945 g/cm³; a melt index (I₂) from 0.1 to 10; a melt flow ratio (I₁₀/I₂) from 10 to 20; a melt flow ratio (I₂₁/I₂) from 15 to 50; a melt strength (190° C.) greater than 8.5 cN; a molecular weight distribution (Mw/Mn) from 2.5 to 5.0; and a reverse comonomer distribution.

Aspect 2 provides the polyolefin composition of aspect 1, wherein the polyolefin composition has Mn from 20,000 to 100,000; a Mw from 100,000 to 300,000; and a Mz from 300,000 to 1,000,000.

Aspect 3 provides the polyolefin composition of any one of aspects 1-2, wherein the polyolefin composition provides a film dart impact from 700 to 1200 grams.

Aspect 4 provides the polyolefin composition of any one of aspects 1-3, wherein the polyolefin composition has a molecular weight comonomer distribution index (MWCDI) greater than 1.

Aspect 5 provides the polyolefin composition of any one of aspects 1-4, wherein ethylene is utilized as a monomer and hexene is utilized as a comonomer.

Aspect 6 provides the polyolefin composition of any one of aspects 1-5, wherein the polyolefin composition is unimodal.

Aspect 7 provides a film made with the polyolefin composition of any one of aspects 1-6.

Aspect 8 provides a method for making the polyolefin composition of any one of aspects 1-6, the method comprising: making a catalyst composition utilizing an asymmetrical hafnium metallocene; and contacting the catalyst composition and ethylene and, optionally, a comonomer selected from the group consisting of propene and a (C₄-C₂₀)alpha-olefins to make the polyolefin composition.

Aspect 9 provides a method for making the polyolefin composition of any one of aspects 1-6, the method comprising: making a catalyst composition utilizing an asymmetrical hafnium metallocene having an n-propyl cyclopentadienyl ligand represented by structure (I):

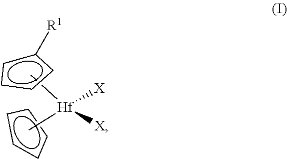

wherein R¹ n-propyl; and each X is independently a leaving group; and contacting the catalyst composition and ethylene and, optionally, a comonomer selected from the group consisting of propene and a (C₄-C₂₀)alpha-olefins to make the polyolefin composition.

### EXAMPLES

Hafnium complex I: (n-Propylcylopentadienyl)hafnium trichloride, dimethoxyethane adduct, which may be represented by the following formula:

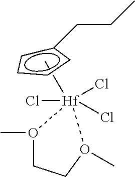

was synthesized as follows. The (n-Propylcylopentadienyl)hafnium trichloride, dimethoxyethane adduct was synthesized as follows (e.g., by adapting the procedure described in WO2016/168448A1 by Harlan). Bis-(n-propylcyclopentadienyl) hafnium dichloride was commercially obtained from TCl; Bis(n-propylcyclopentadienyl) hafnium dichloride (25.1 g, 54.1 mmol) was heated to 140° C. in a 100 mL round-bottom flask until melted. HfCl₄ (17.5 g, 54.6 mmol) was added to the flask as a solid powder. The contents of the flask were heated at 140° C. for approximately 30 minutes and formed a brown viscous liquid. The 100 mL round bottom flask was attached to a short path distillation apparatus, which consisted of a glass tube (90° bend) that was attached to a Schlenk flask. A vacuum was pulled through a stopcock of the Schlenk flask. Distillation was performed from 105° C. to 110° C. with 0.4 torr vacuum. In approximately one hour, it was observed that most of the material distilled/sublimed into the Schlenk flask or remained in the glass tube. The solid material in the u-tube was scraped out and combined with the material in the Schlenk flask. To this solid was added toluene (50 mL) and dimethoxyethane (50 mL). This was heated to reflux forming a solution, additional toluene (50 mL) was added. Upon cooling colorless needles formed. Pentane (200 mL) was added causing further formation of solid precipitate. The solid was isolated by filtration, washed with pentane (2×50 mL) and dried under vacuum to provide (n-Propylcylopentadienyl)hafnium trichloride, dimethoxyethane adduct (42.2 g); cooling the combined supernatant and washings resulted an additional 2.6 g of product that was isolated.

Example 1-1, an asymmetrical hafnium metallocene having an n-propyl cyclopentadienyl ligand, which may be represented by the following structure (II):

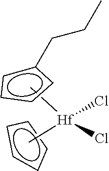

was synthesized as follows. For the above formula, R¹, as previously discussed, is (n-propyl). In a glove box, propylcyclopentadienyl hafniumtrichloride dimethoxy ethane adduct (0.75 g, 1.56 mmol) was added to a container (oven-dried 4 oz. glass jar); a teflon-coated stir bar and 40 mL of dry toluene (40 mL) were added to the container and the contents were stirred. The contents were observed to be grey and cloudy. Cyclopentadienyllithium (1 molar equivalent) was slowly added the container; then, the contents of the container were stirred for approximately 12 hours at approximately 20° C. NMR spectra indicated formation of Example 1-1, as well as some unreacted starting material. The contents of the container were further stirred for approximately 120 hours at approximately 20° C.; then, the contents of the container were filtered and volatiles were removed under reduced pressure. The solids were recrystallized from warm hexanes and toluene; the resultant solids (Example 1-1) were isolated (63.9% total yield after recrystallization). 1H and 13C NMR spectra confirmed Example 1-1. ¹H NMR (400 MHZ, Benzene-d₆) δ 5.86 (s, 3H), 5.77-5.72 (m, 2H), 5.57 (t, J=2.7 Hz, 2H), 2.63-2.54 (m, 2H), 1.48-1.35 (m, 2H), 0.80 (t, J=7.3 Hz, 3H). ¹³C NMR (101 MHZ, Benzene-d₆) δ 132.81, 115.78, 114.13, 110.86, 32.38, 24.34, 14.00.

Example 1-2, a spray-dried composition, was made as follows. To a container (13 gallon tank) hydrophobic fumed silica (CABOSIL TS-610; 2.38 pounds) and a 10% solution (37.0 pounds) by weight of methylaluminoxane (MAO) in toluene were added while mixing. Then, Example 1-1 (80 grams) and toluene (20 pounds) were added to the contents of the container while mixing. Then, the contents of the container were spray-dried (146° C. inlet temperature; 84° C. outlet temperature; 14 lbs/hr slurry inlet feed, 20000 rpm atomizer speed) to provide Example 1-2 (4.1 pounds).

Example 1-3 (polyolefin composition) was made utilizing Example 1-2 as follows. The polymerization utilized a pilot scale fluidized bed gas phase polymerization reactor that included a reactor vessel containing a fluidized bed of a powder of ethylene/alpha-olefin copolymer, and a distributor plate disposed above a bottom head, and defining a bottom gas inlet, and having an expanded section, or cyclone system, at the top of the reactor vessel to decrease resin fines that may escape from the fluidized bed. The expanded section defined a gas outlet. The reactor further included a compressor blower that was utilized to continuously cycle gas around from out of the gas outlet in the expanded section in the top of the reactor vessel through a cycle loop down to and into the bottom gas inlet of the reactor and through the distributor plate and fluidized bed. The reactor further included a cooling system that removed heat of polymerization and maintained the fluidized bed at a target temperature. Compositions of gases such as ethylene, alpha-olefin, and hydrogen were fed into the reactor and monitored by an in-line gas chromatograph in the cycle loop to maintain specific concentrations that were used to control polymer properties. The spray-dried catalyst was fed as a slurry or dry powder into the reactor from high pressure devices, wherein the slurry was fed via a syringe pump and the dry powder was fed via a metered disk. The catalyst entered the fluidized bed in the lower ⅓ of the bed height. The polymerization system weighed the fluidized bed and included isolation ports that discharged the polymerization product from the reactor vessel in response to an increase of the fluidized bed weight as the polymerization reaction proceeded. Polymerization conditions are reported in Table 1.

Example 1-4 (polyolefin composition) was made utilizing Example 1-2, as a trim component, as follows. Spray dried MAO Slurry (SDMAO)-14 wt % SDMAO, 10 wt % hexane, 76 wt % Hydrobite 380 mineral oil (obtained from Sonneborn, LLC). Spray dried MAO was prepared as a dry powder by adapting the procedure according to U.S. Pat. No. 8,497,330 B2, column 22, lines 48, to 67. The adapted procedure omitted the addition of a metallocene compound; the toluene, methylaluminoxane (MAO may be obtained from AkzoNobel), Cabosil slurry is instead introduced to the atomizing device to produce the SDMAO as a dry powder. Polymerization conditions are reported in Table 1.

Commercial polymers were utilized as Comparative Examples A-G: Comparative Example A (INNATE ST50, obtained from The Dow Chemical Company); Comparative Example B (polymer made with XCAT VP-100, obtained from Univation Technologies); Comparative Example C (DOWLEX 2020G, obtained from The Dow Chemical Company); Comparative Example D (polymer made with XCAT J, obtained from Univation Technologies); Comparative Example E (DOWLEX GM 8070G, obtained from The Dow Chemical Company); Comparative Example F (DOWLEX 2685G, obtained from The Dow Chemical Company.

A number of properties were determined for the polyolefin compositions. The results are reported in the following tables. Melt index (I₂) was determined according to ASTM D1238 (190° C., 2.16 kg), flow index (I₁₀) was determined according to ASTM D1238; flow index (I₂₁) was determined according to ASTM D1238 (190° C., 21.6 kg); Mw, Mn, Mz, and Mw/Mn were determined by GPC; molecular weight comonomer distribution index (MWCDI) was determined as discussed herein. Melt strength (190° C.) was determined by the Melt Strength Measurement process, as discussed herein. Film dart impact was determined according to ASTM D1709.

TABLE 1

| | Example | Example |
|---|---|---|
| | 1-3 | 1-4 |
| Reaction Temp | 75 | 80 |
| (° C.) | | |
| C₆/C₂ | 0.0152 | 0.0224 |
| (molar ratio) | | |
| H₂/C₂ | 0.0005 | 0.0005 |
| (molar ratio) | | |
| C₂ | 191 | 131 |
| Partial Pressure | | |
| (psi) | | |
| Catalyst slurry | 16 | 22 |
| feed rate | | |
| (cm³/hr) | | |
| Reactor pressure | 350 | 350 |
| (psi) | | |
| Average residence | 4.01 | 6.65 |
| time | | |
| (hr) | | |

TABLE 2

| | | Example | Example |
|---|---|---|---|
| | | 1-3 | 1-4 |
| Modality | | Unimodal | Unimodal |
| Comonomer | | C₆ | C₆ |
| Density | g/cm³ | 0.9189 | 0.923 |
| Melt Index | dg/min | 0.21 | 0.36 |
| (I₂) | | | |
| Flow Index | dg/min | 2.3 | 3.9 |
| (I₁₀) | | | |
| I₁₀/I₂ | | 11.0 | 10.4 |
| Ratio | | | |
| Flow Index | dg/min | 7.6 | 11.3 |
| (I₂₁) | | | |
| I₂₁/I₂ | | 36.3 | 31.4 |
| Ratio | | | |
| Mn | g/mol | 47,140 | 38,073 |
| Mw | g/mol | 195,127 | 148,931 |
| Mw/Mn | g/mol | 4.14 | 3.9 |
| Mz | g/mol | 645,780 | 460,814 |
| MWCDI | | 7.34 | 5.4 |
| Melt | cN | 14.7 | 13.8 |
| strength | | | |
| 190° C. | | | |

TABLE 3

| | | Example |
|---|---|---|
| | | 1-4 |
| Dart Drop | g/mil | 596 |
| Impact | | |
| (Method A) | | |
| Instrumented | g/mil | 52.05 |
| Dart Impact | | |
| Elmendorf | g/mil | 355 |
| Tear (CD) | | |
| Elmendorf | g/mil | 177 |
| Tear (MD) | | |
| Gloss −45 | % | 49.94 |
| degree | | |
| Puncture | ft-lbf/in\hat{ }3 | 94.6 |
| Modulus-CD | psi | 44027 |
| Secant | psi | 42462 |
| Modulus - | | |
| CD at 1% | | |
| strain | | |
| Secant | psi | 36434 |
| Modulus -CD | | |
| at 2% strain | | |
| Modulus-MD | psi | 34735 |
| Secant | psi | 34706 |
| Modulus- | | |
| MD at 1% | | |
| strain | | |
| Secant | psi | 33624 |
| Modulus MD | | |
| at 2% strain | | |
| Tensile MD | % | 509 |
| Strain at | | |
| Break | | |
| Tensile MD - | % | 10 |
| Strain at | | |
| Yield | | |
| Tensile MD - | psi | 7298 |
| Break Stress | | |
| Tensile MD - | psi | 1684 |
| Stress at | | |
| Yield | | |
| Tensile CD - | % | 608 |
| Strain at | | |
| Break | | |
| Tensile CD - | % | 10 |
| Strain at | | |
| Yield | | |
| Tensile CD - | psi | 1718 |
| Stress at | | |
| Yield | | |
| Tensile CD - | psi | 6843 |
| Break Stress | | |

TABLE 4

| | | Comp. | Comp. | Comp. | Comp. | Comp. | Comp. |
|---|---|---|---|---|---|---|---|
| | | Ex. A | Ex. B | Ex. C | Ex. D | Ex. E | Ex. F |
| Modality | | B | U | U | U | U | U |
| Comonomer | | C₆ | C₆ | C₆ | C₆ | C₆ | C₆ |
| Density | g/cm³ | 0.918 | 0.916 | 0.9221 | 0.9235 | 0.918 | 0.9221 |
| Melt Index | dg/min | 0.85 | 0.5 | 0.5 | 0.5 | 0.9 | 0.75 |
| (I₂) | | | | | | | |
| Flow Index | dg/min | 6.8 | 4.1 | 4.01 | 4.1 | 6.6 | 5.8 |
| (I₁₀) | | | | | | | |
| I₁₀/I₂ | | 8.0 | 8.0 | 8.0 | 8.1 | 7.3 | 7.7 |
| Ratio | | | | | | | |
| Flow Index | dg/min | 28.8 | — | — | 11.7 | — | — |
| (I₂₁) | | | | | | | |
| I₂₁/I₂ | | 33.9 | — | — | 23.4 | — | — |
| Ratio | | | | | | | |
| Mn | g/mol | 28582 | 33959 | 32648 | 35493 | 29381 | 28426 |
| Mw | g/mol | 113367 | 305642 | 145230 | 149196 | 120767 | 124195 |
| Mw/Mn | g/mol | 4.0 | 3.9 | 4.4 | 4.2 | 4.1 | 4.4 |
| Mz | g/mol | 284989 | 332278 | 460727 | 508075 | 393354 | 384946 |
| MWCDI | | 4.71 | 7.52 | −2.64 | −4.19 | −2.29 | −1.70 |
| Melt strength | cN | 4.2 | 5.38 | 5.3 | 5.76 | 4.3 | 4.1 |
| 190° C. | | | | | | | |
| Dart Drop | gmf/mil | 1047 | 593 | 623 | 254 | 621 | 684 |
| Impact | | | | | | | |
| (Method A) | | | | | | | |
| Instrumented | gmf/mil | 65.02 | 59.78 | 61.60 | 23.14 | 35.52 | 31.20 |
| Dart Impact | | | | | | | |
| Elmendorf | | 515.0 | 334 | 739.1 | 827.8 | 517.5 | 551.8 |
| Tear (CD) | | | | | | | |
| Elmendorf | | 275.0 | 375 | 395.8 | 500.5 | 378.8 | 423.5 |
| Tear (MD) | | | | | | | |
| Gloss | % | 46.12 | 35.7 | 59.5 | 80.97 | 59.94 | 33.5 |
| Puncture | ft-lbf/ | 104.9 | 174.4 | 139.9 | 59.2 | 144.0 | 149.3 |
| | in\hat{ }3 | | | | | | |
| Modulus-CD | psi | 45184 | — | 38383 | 40771 | 31894 | 34654 |
| Secant | psi | 39549 | — | 35918 | 38735 | 29845 | 32753 |
| Modulus - CD | | | | | | | |
| at 1% strain | | | | | | | |
| Secant | psi | 32593 | — | 30769 | 32945 | 25555 | 28207 |
| Modulus -CD | | | | | | | |
| at 2% strain | | | | | | | |
| Modulus-MD | psi | 38011 | — | | 36394 | 27408 | 29990 |
| Secant | psi | 34419 | — | 32061 | 34593 | 26776 | 29182 |
| Modulus- MD | | | | | | | |
| at 1% strain | | | | | | | |
| Secant | psi | 28960 | — | 28883 | 30120 | 24494 | 26216 |
| Modulus MD | | | | | | | |
| at 2% strain | | | | | | | |
| Tensile MD | % | 611 | 628 | 442 | 472 | 525 | 476 |
| Strain at Break | | | | | | | |
| Tensile MD - | % | 13 | 10 | 8 | 12 | 10 | 12 |
| Strain at Yield | | | | | | | |
| Tensile MD - | psi | 8375 | 8659 | 9537 | 9274 | 9101 | 8852 |
| Break Stress | | | | | | | |
| Tensile MD - | psi | 1462 | 1421 | 1216 | 1405 | 1222 | 1232 |
| Stress at Yield | | | | | | | |
| Tensile CD - | % | 673 | 583 | 655 | 694 | 689 | 692 |
| Strain at Break | | | | | | | |
| Tensile CD - | % | 12 | 13 | 10 | 14 | 10 | 11 |
| Strain at Yield | | | | | | | |
| Tensile CD - | psi | 1427 | 1328 | 1279 | 1466 | 1144 | 1226 |
| Stress at Yield | | | | | | | |
| Tensile CD - | psi | 7398 | 8911 | 7554 | 5847 | 6454 | 6808 |
| Break Stress | | | | | | | |

For Table 4, “U” indicates unimodal modality and “B” indicates bimodal modality.

The data of Table 2 illustrate that Examples 1-3 and 1-4 each (polyolefin compositions made with Example 1-2) had a molecular weight comonomer distribution index (MWCD) greater than 1, i.e. a reverse comonomer distribution.

The data of Table 2 illustrate that polyolefin compositions Example 1-3 and 1-4 each had a density from 0.910 to 0.945 g/cm³.

The data of Table 2 illustrate that polyolefin compositions Example 1-3 and 1-4 each had a melt index (I₂) from 0.1 to 10.

The data of Table 2 illustrate that polyolefin compositions Examples 1-3 and 1-4 each had an I₁₀/I₂ from 10 to 20.

The data of Table 2 illustrate that polyolefin compositions Examples 1-3 and 1-4 each had an I₂₁/I₂ from 15 to 50.

The data of Table 2 illustrate that polyolefin compositions Examples 1-3 and 1-4 each had Mw/Mn from 2.5 to 5.0.

The data of Table 2 illustrate that polyolefin compositions Example 1-3 and 1-4 each had a melt strength (190° C.) greater than 8.5 cN.

1. A polyolefin composition, wherein the polyolefin composition has:
a density from 0.910 to 0.945 g/cm³;
a melt index (I₂) from 0.1 to 10;
a melt flow ratio (I₁₀/I₂) from 10 to 20;
a melt flow ratio (I₂₁/I₂) from 15 to 50;
a melt strength (190° C.) greater than 8.5 cN;
a molecular weight distribution (Mw/Mn) from 2.5 to 5.0; and
a reverse comonomer distribution.

2. The polyolefin composition of claim 1, wherein the polyolefin composition has a Mn from 20,000 to 100,000; a Mw from 100,000 to 300,000; and a Mz from 300,000 to 1,000,000.

3. The polyolefin composition of claim 1, wherein the polyolefin composition provides a film dart impact from 700 to 1200 grams.

4. The polyolefin composition of claim 1, wherein the polyolefin composition has a molecular weight comonomer distribution index (MWCDI) greater than 1.

5. The polyolefin composition of claim 1, wherein ethylene is utilized as a monomer and hexene is utilized as a comonomer.

6. The polyolefin composition of claim 1, wherein the polyolefin composition is unimodal.

7. A film made with the polyolefin composition of claim 1.

8. A method for making the polyolefin composition of claim 1, the method comprising:
making a catalyst composition utilizing an asymmetrical hafnium metallocene; and
contacting the catalyst composition and ethylene and, optionally, a comonomer selected from the group consisting of propene and a (C₄-C₂₀)alpha-olefins to make the polyolefin composition.

9. A method for making the polyolefin composition of claim 1, the method comprising:
making a catalyst composition utilizing an asymmetrical hafnium metallocene having an n-propyl cyclopentadienyl ligand represented by structure (I): 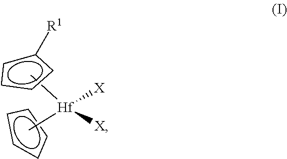
wherein R¹ n-propyl; and each X is independently a leaving group; and contacting the catalyst composition and ethylene and, optionally, a comonomer selected from the group consisting of propene and a (C₄-C₂₀)alpha-olefins to make the polyolefin composition.
